(19) United States
(12) Patent Application Publication
(10) Pub. No.: US 2026/0100589 A1
(43) Pub. Date: Apr. 9, 2026

(54) Asset Fuel-Reserve Based Microgrid Control Strategy

(71) Applicant: Caterpillar Inc., Peoria, IL (US)

(72) Inventors: Guhan Sidharth M, Bengaluru (IN); Manoj Kumar Bantupalli, Vizianagaram (IN); Ranjay Singh, Kanpur (IN)

(73) Assignee: Caterpillar Inc., Peoria, IL (US)

(21) Appl. No.: 18/910,189

(22) Filed: Oct. 9, 2024

(51) Int. Cl. H02J 3/46; G06Q 30/0201; G06Q 50/06; H02J 3/00; H02J 3/28; H02J 13/00

(52) U.S. Cl. CPC H02J 3/466; H02J 3/003; H02J 3/28; H02J 13/12; H02J 13/13; G06Q 30/0206; G06Q 50/06; H02J 2101/24; H02J 2101/28; H02J 2103/35

(57) ABSTRACT

A refueling prediction mode in a microgrid power system may include inputting historical load and weather date of the microgrid power system to a forecasting block and determining forecasted site load and weather factors for the microgrid power system. The forecasted site load and weather factors may be used along with fuel efficiency curves and asset fuel levels for power assets of the microgrid power system, along with other information, to determine an asset dispatch schedule and a refueling timeline for the power assets. Asset dispatch commands based on the asset dispatch schedule and an actual site load may be output to the power assets to meet the load demand on the microgrid power system. A sustained reliability mode may use the information plus real-time fuel costs for the power assets to determine an asset dispatch schedule for longest microgrid sustenance for the power assets.

### TECHNICAL FIELD

The present disclosure relates generally to microgrid power systems and, more particularly, to asset fuel-reserve based microgrid control strategies.

### BACKGROUND

A microgrid can use energy produced by different types of energy assets, such as generator sets (or gensets), battery energy storage systems (ESSs), photovoltaic sources (e.g., solar panels), wind turbines, hydro-electric power, pumped hydro-electric, fuel cells, hydrogen production and storage, etc., to provide power to the load or loads of the microgrid. It is desirable to control the microgrid to provide reliable power to meet load demands with objectives such as minimizing operating cost and emissions, maximizing use of renewable energy sources, or optimizing a mix of these objectives while operating within economic, asset and site constraints placed on the microgrid. In current systems, current fuel reserves of fuel-driven energy assets are omitted from control strategies and asset dispatch calculations. Moreover, microgrid controllers are not provided with forecasted refueling of energy assets, and current systems do not provide any forecast for refueling of fuel-driven energy assets based on the expected asset dispatch. Hence, refueling is typically performed immediately when critically low fuel levels are observed at the assets.

### SUMMARY OF THE DISCLOSURE

In one aspect of the present disclosure, a method for refueling prediction in a microgrid power system is disclosed. The method may include inputting historical load and weather date of the microgrid power system to a forecasting block, determining, at the forecasting block, forecasted site load and weather factors for the microgrid power system, inputting the forecasted site load and weather factors to a microgrid controller block, and inputting fuel efficiency curves and asset fuel levels for power assets of the microgrid power system to the microgrid controller block. The method may further include determining, at the microgrid controller block, an asset dispatch schedule for the power assets of the microgrid power system based on the forecasted site load and weather factors, determining, at the microgrid controller block, a refueling timeline for the power assets of the microgrid power system based on the forecasted site load and weather factors, the fuel efficiency curves and the asset fuel levels, outputting the refueling timeline to a monitor of the microgrid power system, determining, at real-time asset dispatch block, asset dispatch commands based on the asset dispatch schedule and an actual site load, and outputting the asset dispatch commands to the power assets of the microgrid power system.

In another aspect of the present disclosure, a method for sustained reliability of a microgrid power system is disclosed. The method may include inputting historical load and weather date of the microgrid power system to a forecasting block, determining, at the forecasting block, forecasted site load and weather factors for the microgrid power system, inputting the forecasted site load and weather factors to a microgrid controller block, inputting fuel efficiency curves and asset fuel levels for power assets of the microgrid power system to the microgrid controller block, and inputting real-time fuel costs for the power assets to the microgrid controller block. The method may further include determining, at the microgrid controller block, an asset dispatch schedule for longest microgrid sustenance for the power assets of the microgrid power system based on the forecasted site load and weather factors, the fuel efficiency curves and the asset fuel levels, and the real-time fuel costs, determining, at real-time asset dispatch block, asset dispatch commands based on the asset dispatch schedule and an actual site load, and outputting the asset dispatch commands to the power assets of the microgrid power system.

In a further aspect of the present disclosure, a microgrid power system is disclosed. The microgrid power system may include a microgrid load requiring power from the microgrid system, a plurality of power assets of different power asset types providing power to the microgrid power system, an electronic network connecting the microgrid load and the plurality of power assets for transferring power and for communicating monitoring and control information, and a microgrid controller operatively connected to the microgrid load, the plurality of power assets and the electronic network. The microgrid controller may be configured to receive historical load and weather date of the microgrid power system, determine forecasted site load and weather factors for the microgrid power system, receive fuel efficiency curves and asset fuel levels for the plurality of power assets. The microgrid controller may be further configured to determine an asset dispatch schedule for the power assets of the microgrid power system based on the forecasted site load and weather factors, determine a refueling timeline for the plurality of power assets based on the forecasted site load and weather factors, the fuel efficiency curves and the asset fuel levels, output the refueling timeline to a monitor of the microgrid power system, determine asset dispatch commands based on the asset dispatch schedule and an actual site load, and output the asset dispatch commands to the power assets of the microgrid power system.

Additional aspects are defined by the claims of this patent.

### BRIEF DESCRIPTION OF THE DRAWINGS

FIG. 1 is a schematic illustration of a microgrid power system in which microgrid control strategies in accordance with the present disclosure may be implemented;

FIG. 2 is a schematic illustration of microgrid controller in accordance with the present disclosure of the microgrid power system of FIG. 1;

FIG. 3 is an information flow diagram of a refueling prediction mode in accordance with the present disclosure implemented with the microgrid controller of FIG. 2;

FIG. 4 is a flow diagram of a refueling prediction mode routine in accordance with the present disclosure;

FIG. 5 is an information flow diagram of a sustained reliability mode in accordance with the present disclosure implemented with the microgrid controller of FIG. 2; and

FIG. 6 is a flow diagram of a sustained reliability mode routine in accordance with the present disclosure.

### DETAILED DESCRIPTION

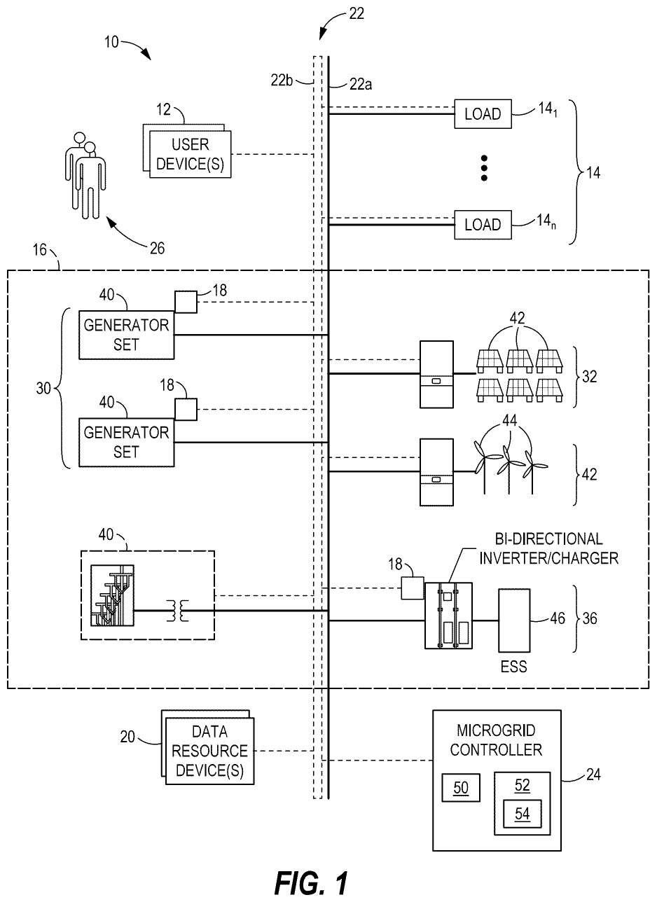

FIG. 1 depicts an exemplary microgrid power system 10 in which asset fuel-reserve based microgrid control strategies in accordance with the present disclosure may be implemented. One or more user devices 12, a load or loads 14, a plurality of power asset groups 16, sensors 18 and one or more data resource devices 20 may be operatively connected to each other and/or may communicate across an electronic network 22. The electronic network 22 may include a high voltage (HV) bus 22a over which electric power is exchanged between the components of the microgrid power system 10, and a communication network 22b, such as a local area network (LAN) or other appropriate network, to communicate monitoring and control information between the devices to control operation of the microgrid power system 10. The HV bus 22a may include switches (not shown) that receive control signals over the communication network 22b to operate to direct the flow of electric power over the HV bus 22a. As will be discussed in further detail below, one or more microgrid controllers 24 may communicate with one or more of the other components of the microgrid power system 10 across the electronic network 22. The user devices 12 may be associated with a user 26, e.g., a user 26 associated with one or more of managing, maintaining, inspecting, repairing, operating, or controlling the microgrid power system 10, or the like.

Each user device 12 may be configured to enable a user 26 to access and/or interact with other devices in the microgrid power system 10. For example, the user device 12 may be a computer system such as, for example, a desktop computer, a mobile device, a tablet, etc. The user device 12 may include a client hosted on one or more remote systems, e.g., in a cloud architecture, distributed computing cluster, or the like, and may include and/or access an embedded controller, an application specific circuit or processor, or the like. The user device 12 may include one or more electronic applications, e.g., a program, plugin, browser extension, etc., installed on a memory of the user device 12, and the electronic applications may be associated with one or more of the other components in the microgrid power system 10. For example, the electronic applications may include one or more of system control software, system monitoring software, scheduling tools, load analysis tools, forecasting tools, etc. The electronic applications, such as the foregoing examples, may be configured to enable a user to select, modify, and/or control various options and/or behaviors of the microgrid power system 10. The user device 12 may be configured to generate, implement, and/or display a Human-Machine-Interface (HMI) for the microgrid power system 10, and/or other information or interactive tools such as, for example, diagnostic processes, forecasting processes, scheduling processes, or the like.

The load 14 may include any number of loads 14₁-14ₙ that may be systems, devices, or the like to be powered by the hybrid control system such as, for example, building electronic power systems, air conditioning systems, machines, propulsion devices, or the like. In some instances, a portion of the load 14 may be essential or non-discretionary that requires power as demanded, such as power for life support systems or refrigeration units in a patient care environment. Other portions of the load may be non-essential or discretionary such that power can be reduced or withheld when the power available from the power asset groups 16 is insufficient to meet the total power demand of the load 14. A portion of the load 14 may be automatic, e.g., a system or device that has a predetermined schedule of operation, and/or may be at least partially predictable, e.g., systems or devices like air conditioning system that operate in correlation to ambient temperature or building electronic power systems that operate in correlation to business hours, or the like. In some instances, a portion of the load 14 may be user controlled, such as appliances, machines, or the like, and/or may be controllable by the microgrid power system 10. For example, in some instances, the microgrid controller 24 may deactivate a portion of the load 14 when the power required by the load 14 exceeds power available from the microgrid power system 10.

The plurality of power asset groups 16 may include any suitable number of power asset groups. In the embodiment of the microgrid power system 10 depicted in FIG. 1, the plurality of power asset groups 16 includes a genset group 30, a PV group 32, a wind turbine group 34, an energy storage system (ESS) group 36, and a power grid connection 38. It should be understood that in various embodiments, various power asset groups may be included or omitted in a hybrid power system instead of or in addition to the groups listed above, and that the power asset groups listed above are exemplary only, and any suitable power asset group or groups may be included in any suitable arrangement. Power assets within a power asset group may be operatively connected within the microgrid power system 10 in any suitable manner. For example, in some instances, power assets within a power asset group may be connected in one or more banks, e.g., in parallel or in series. In some embodiments, individual power assets may be individually connected, or may be connected to the microgrid power system 10 via intermediary devices such as a transformer, a sub-station, an inverter, a rectifier, a load balancer, an electrical bus, a tie breaker, or the like. In some embodiments, a power asset may include and/or be integrated with one or more sensor 18. For example, a power asset may include a sensor configured to detect one or more of or power output, voltage, frequency, ambient temperature, operating temperature, operational duration, etc.

The genset group 30 may include a plurality of gensets 40. The gensets 40 of the genset group 30 are fuel-type power assets that can be diesel fueled, gas reciprocating, gas turbine, hydrogen reciprocating, hydrogen turbine, blended fuel gensets and the like. The gensets 40 may have operational characteristics such as apparent power limits, active power rating limits, power factor range limits, a predetermined, regulated, and/or designed minimum load capacity, a start/stop frequency limit or threshold, a maximum load capacity, total operational lifetime, current operational age, fuel capacity, fuel consumption rate, power output, maintenance cost, replacement cost, etc. Such characteristics may be predetermined, e.g., set during manufacture or established via regulatory requirement, or may vary over the course of operation or the lifetime of the gensets 40. One or more aspects of such characteristics (e.g., one or more fuel consumption maps) may be sensed via sensors 18, simulated, mapped, tracked, and/or predicted via the data resource device 20, the microgrid controller 24, or the like.

The PV group 32 may include a plurality of PV devices 42 such as cells, banks of cells, or the like. The PV devices 42 may be characterized by maximum power output, a relation between irradiance of the PV device 42 and power output, a device lifetime, a device age, a replacement cost, etc. One or more aspects of such characteristics may be sensed via sensors 18, simulated, mapped, tracked, and/or predicted via the data resource device 20, the microgrid controller 24, or the like. One or more aspects of such characteristics (e.g., cloud coverage, weather, temperature, or the like as well as associated characteristics such as irradiance and power capability forecasting) may be sensed via sensors 18, simulated, mapped, tracked, and/or predicted via the data resource device 20, the microgrid controller 24, or the like.

The wind turbine group 34 may include a plurality of wind turbines 44. The wind turbines 42 may be characterized by maximum power output, a relation between rotational speed of the wind turbine 42 and power output, a device lifetime, a device age, a replacement cost, etc. One or more aspects of such characteristics may be sensed via sensors 18, simulated, mapped, tracked, and/or predicted via the data resource device 20, the microgrid controller 24, or the like. One or more aspects of such characteristics (e.g., wind speed, weather, or the like as well as associated characteristics such as rotational speed and power capability forecasting) may be sensed via sensors 18, simulated, mapped, tracked, and/or predicted via the data resource device 20, the microgrid controller 24, or the like.

The ESS group 36 may include a plurality of energy storage systems (ESSs) 46. In the embodiment depicted in the microgrid power system 10 in FIG. 1, the ESSs 46 are batteries or banks of batteries. However, in various embodiments, any suitable type of ESS 46 may be used such as, for example, a flywheel, a thermal ESS, pumped hydro-electric storage, pneumatic energy storage, etc.

The ESS 46 may be characterized by a state-of-charge (SOC), depth of discharge (DOD), a discharge energy cost, a charge energy cost, total lifetime, replacement cost, calendar aging, cycling aging, operating temperature, etc. One or more aspects of such characteristics such as temperature, state of health, age, voltage, current, or the like may be sensed via sensors 18, simulated, mapped, tracked, and/or predicted via a management system of the ESS 46 (e.g., a battery management system), the data resource device 20, the microgrid controller 24, or the like.

The power grid connection 38 may be usable to supply power to the microgrid power system 10 from a power grid and/or export power out from the microgrid power system 10 into the power grid. The power grid connection 38 may be characterized by an energy cost for supplying power to the microgrid power system 10, an energy revenue for supplying power from the microgrid power system 10 to the power grid. In some instances, the energy cost and energy revenue for the power grid connection 38 may vary over time, e.g., due to demand, incentives, or other factors. One or more aspects of such characteristics (e.g., current and/or day-ahead prices by hour of day or the like, energy import/export limits or rules, energy concessions, trading, or commitments, etc.) may be retrieved, simulated, mapped, tracked, and/or predicted (e.g., via the data resource device 20, the microgrid controller 24, or the like).

The sensors 18 may include any suitable number of sensors. The sensor 18 may be configured to sense one or more characteristics of one or more power assets in the plurality of power asset groups 16. For example, a temperature sensor may be used to sense a temperature of an ESS 46, a flow meter may be used to sense a fuel consumption rate of a genset 40, and/or an electrical sensor (e.g., a voltage, current, or power sensor, or the like), may be used to sense one or more aspects of power provided by a particular power asset, power drawn by the load 14, or the SOC or DOD of an ESS 46. A timer may be used to track how long a power asset, e.g., a genset 40, has been operating. A fuel meter may sense real-time fuel consumption by a genset and/or genset group, and/or fuel reserve availability in the genset and/or genset group. A gas sensor may be used to sense emissions, e.g., from the genset group 30. In some embodiments, power assets of the power asset groups 16, such as the PV group 32, the wind turbine group 34 and the ESS group 36 as shown in FIG. 1, may incorporate sensors and/or may be configured to output operational data indicative of characteristics of the power assets.

The data resource device 20 may include a server system, an electronic data system, computer-readable memory such as a hard drive, flash drive, disk, etc. In some embodiments, the data resource device 20 includes and/or interacts with an application programming interface for exchanging data to other systems, e.g., one or more of the other components of the microgrid power system 10. The data resource device 20 may include and/or act as a repository or source for data associated with the characteristics of the power assets in the plurality of power asset groups 16. In various embodiments, the data resource device 20 may include one or more of a device manager, device controller, a telematics system (e.g., for off-board data collection), an on-board and/or off-board data repository, or the like.

The data resource device 20 may be configured to obtain, generate, and/or store data such as, for example, one or more characteristics of the power assets in the plurality of power assets 16, characteristics of the load 14, weather and/or cloud data associated with forecasting a power availability for the PV group 32 or the wind turbine group 34, costs of fuel for the genset group 30, import and export rates for the power grid connection 38. In some instances, the data resource device 20 may use historical data to generate forecast data. For example, the data resource device 20 may use historical information about the load 14 in order to generate a load forecast that predicts or estimates an amount of power needed by the load at, for example, different times of day, different days of the week, in different seasons, during different weather or ambient temperature conditions, etc. In another example, historical data may be used to estimate or predict a next day's prices of import and export of power via the power grid connection 38, or of costs for fuel for the genset group 30. In some embodiments, the data resource device 20 may use machine learning, e.g., deep learning, stochastic techniques, probabilistic techniques or other techniques, to generate forecasts.

The data resource device 20 may be configured to generate and/or obtain an optimal performance map for one or more power assets of the plurality of power asset groups 16. In various embodiments, an optimal performance map may be generated based on actual data associated with the power assets and/or simulation data based on simulation of the power assets. In one example, optimal performance maps may be obtained that describe various scenarios of operating different and/or different numbers of gensets 40 in the genset group 30. An optimal performance map may map efficiency and/or cost versus aggregate power, and/or may indicate optimal loading of various power assets for different aggregate power amounts. The optimal performance maps may indicate how much power may be available from each power asset, the energy cost for each power asset, or the like, e.g., individually and/or in combination with other power assets. In some embodiments, the data resource device 20 may be configured to generate, obtain, and/or update the optimal performance maps from time to time, e.g., periodically, and/or in response to a trigger condition such as an indication, e.g., from a sensor 18, that performance of a power asset has changed beyond a predetermined threshold. In some embodiments, the optimal performance maps and/or characteristics of the power assets indicated by the optimal performance maps may be used by the microgrid controller 24 when performing optimizations.

In various embodiments, the electronic network 22 may be a wide area network (“WAN”), a local area network (“LAN”), personal area network (“PAN”), Ethernet, or the like. In some embodiments, electronic network 22 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device (e.g., for telematics and/or data collection or transmission.

The microgrid controller 24 may include one or more components to monitor, track, and/or control the operation the microgrid power system 10, e.g., the power assets of the plurality of power asset groups 16. For example, the microgrid controller 24 may include a processor 50 and a memory 52. The microgrid controller 24 may operate as a standalone device or may be connected (e.g., networked) to other machines. In a networked deployment, the microgrid controller 24 may operate in the capacity of a server machine, a client machine, or both in server-client network environments. The microgrid controller 24 may be a personal computer (PC), a tablet PC, a smartphone, an IoT device, or any machine capable of executing instructions (sequential or otherwise) that specify actions to be taken by that machine. Although depicted as a single microgrid controller 24 in FIG. 1, the functionality microgrid controller 24 may be distributed across multiple devices and/or may include multiple control modules that operate in concert to execute a set (or multiple sets) of instructions to perform any one or more of the methodologies discussed herein, such as cloud computing, software as a service (SaaS), other computer cluster configurations.

The processor 50 may be a hardware processor, a central processing unit (CPU), a hardware processor core, application specific integrated circuit (ASIC), a programmable gate array (PGA), or any combination thereof. The processor 50 can be configured to execute instructions stored in the memory 52 for performing the operations and steps discussed herein. The memory 52 may include read-only memory (ROM), dynamic random-access memory (DRAM), static memory or other forms of computer-readable storage medium in various combinations as necessary for a particular implementation of the microgrid power system 10 in accordance with the present disclosure. The term “computer-readable storage medium” should be taken to include a single medium or multiple media that store the one or more sets of instructions (or any medium that can store or encode a set of instructions for execution by the microgrid controller 24) that cause the microgrid controller 24 to perform any one or more of the functions of the microgrid controller 24 described herein. These media can include, among other things, solid-state memories, optical media, and magnetic media.

The memory 52 may store data and/or software, e.g., instructions, models, algorithms, equations, data tables, or the like, that are usable and/or executable by the processor 50 to perform one or more operations for controlling the microgrid power system 10. For example, the microgrid controller 24 may be configured to receive input, e.g., from the plurality of power asset groups 16, the sensors 18, the data resource device 20 and/or any other suitable source, and generate active and reactive power commands for each of the power assets in the power asset groups 16 based on the input. For example, the memory 52 may include one or more optimizers 54 that, when executed by the processor 50, are configured to generate active and reactive power commands that optimize the operation of the microgrid power system 10.

Although depicted as separate components in FIG. 1, it should be understood that a component or portion of a component in the microgrid power system 10 may, in some embodiments, be integrated with or incorporated into one or more other components. For example, a portion of the data resource device 20 may be integrated into the microgrid controller 24 or the like. In another example, the microgrid controller 24 may be integrated with one of the user devices 12. In some embodiments, operations or aspects of one or more of the components discussed above may be distributed amongst one or more other components as suggested above for the microgrid controller 24. Any suitable arrangement and/or integration of the various systems and devices of the microgrid power system 10 may be used to implement the microgrid control strategy in accordance with the present disclosure, and arrangements are contemplated by the inventors.

In some embodiments, the optimizers 54 may be configured to perform constrained optimization to provide asset dispatches for operation of the power asset groups 16 to meet the power demands of the loads 14. Known optimization strategies determine the asset dispatches based on the load 14, economic constraints, such as the cost of fuel for the gensets 40 or the cost of acquiring energy from the power grid 38, asset constraints, such as the power output, limitations on time of operation, and the useful lives of the assets in the power asset groups 16, and site constraints, such as the number and variety of available assets in the power asset groups 16. In some instances, at least a portion of the constraints for the one or more optimizations may be soft constraints, e.g., constraints that weigh in to the optimization but that are not absolute requirements. In some instances, the constraints for the one or more optimizations may be segmented into groups of different priorities. In the case where not all of the constraints may be satisfied simultaneously, the microgrid controller 24 may be configured to meet higher priority constraints in favor of lower priority constraints. In some embodiments, the microgrid controller 24 may be configured to take an action, e.g., generate an active power command of a power asset that, while not satisfying a constraint instantaneously, may enable satisfaction of the constraint at a future time.

The constraints and the grouping of the constraints may vary by implementation of the microgrid power systems 10, and that any suitable constraints and/or grouping of such constraints may be used. Any suitable technique for implementing such constraints in the optimizer 54 may be used. For example, in some embodiments, each constraint may act as a metric. In some embodiments, the metrics may be binary, e.g., a value of zero for a satisfied constraint and a value of one for a violated constraint. In some embodiments, the metrics may have a range of values corresponding to how well or to what extent the constraints are satisfied. The value of the metrics may be associated with, e.g., multiplied by, a weight value associated with the priority of the constraints, e.g., higher weight values for higher priority constraints, and included in a cost function of the optimizer 54 as an additional cost term.

In some embodiments, at least a portion of the constraints for the one or more optimizations may be hard constraints, e.g., that define operating limitations that may not be violated. In some embodiments, at least a portion of the constraints may be set, e.g., activated or deactivated by a user 26, e.g., via the user device 12. Constraints for the one or more optimizations may be based, for example, on customer and/or user specified options (e.g., via user device 12), such as: the ESS group 36 is only to be charged via the PV group 32; load on the genset group 30 is to be distributed proportionally across the gensets 40 in the genset group 30 based on power rating; load on the ESS group 36 is to be distributed proportionally across the ESSs 46 in the ESS group 36 based on power rating; load on the ESS group 36 is to be distributed proportionally across the ESSs 46 in the ESS group 36 based on a current energy capacity; and SOC of the ESSs 46 in the ESS group 36 should be balanced, e.g., based on ESSs that are located proximate to each other, and/or on a total average SOC for the ESS group 36.

While many factors have been considered to optimize the performance of microgrid power systems, previous microgrid controllers and control strategies have not considered information related to fuel availability and its effect on asset dispatch to provide power for a load. Current fuel reserves of assets and such as the gusset group 30, for example, are omitted from dispatch calculations. Additionally, no information is provided by microgrid controllers regarding forecasted refueling of the assets. As a result, refueling of assets is not scheduled. Instead, refueling is performed reactively and immediately when critically low fuel levels are observed.

Microgrid control strategies in accordance with the present disclosure incorporate fuel level, fuel efficiency of assets and real-time fuel costs in addition to the above described constraints used in previous microgrid control strategies. With this additional information, the microgrid controller 24 can provide asset dispatch and asset refueling timelines for the microgrid power system 10.

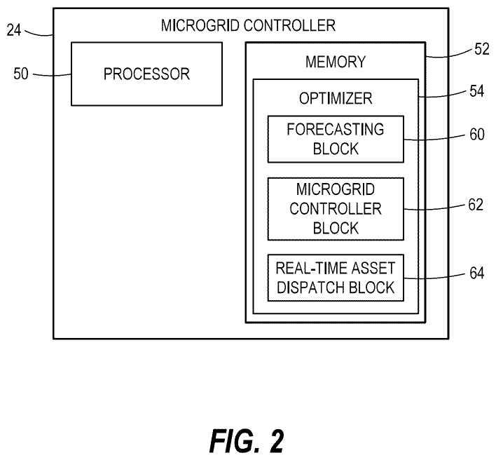

In the microgrid power system 10 in accordance with the present disclosure, the optimizer 54 of the microgrid controller 24 may include building blocks configured to provide the asset refueling timeline. As shown in FIG. 2, the optimizer 54 in the microgrid controller 24 may include a forecasting block 60 and a microgrid controller block 62. The forecasting block 60 may be configured or programmed based on any appropriate forecasting algorithm that provides forecasts of a site load placed on the microgrid power system 10 by the load 14 and weather factors that will have an effect on the operation of the microgrid power system 10, such as irradiance or power of solar radiation, wind speed, humidity and the like. The forecasting block 60 may receive historical load and weather data from, for example, the data resource devices 20, as input for the forecasting algorithm and outputs forecasts for the site load from the load 14 and for the weather factors for the microgrid power system 10. The forecasting block 60 may reside in the microgrid controller 24 itself, or the microgrid controller 24 may receive the forecasted output of a forecasting block 60 from an external third-party source, such as a cloud-based service or the like.

The microgrid controller block 62 may be programmed with algorithms to perform a rule-based analysis, an optimization-based analysis, or a combination of both, based on traditional factors of load demand and economic, asset and site constraints, along with the site load and weather forecast data from the forecasting block 60. The result of the analysis at the microgrid controller block 62 may be an asset dispatch schedule for the power asset groups 16 along with a refueling timeline for the fuel-type assets such as the gensets 40 of the genset group 30. With the asset refueling timeline, the assets can be refueled proactively in a scheduled manner pursuant to the refueling timeline in contrast to the reactive manner required for previous microgrid control strategies.

The real-time asset dispatch block 64 may be configured to implement the microgrid control strategy by outputting asset dispatch commands to the assets in the power asset groups 16. The real-time asset dispatch block 64 may receive the asset dispatch schedule from the microgrid control block 62 that is based on the historical and forecast data, parameters and constraints, as well as real-time data of actual conditions of the microgrid power system 10, such as an actual site load on the microgrid power system 10. The real-time asset dispatch block 64 may then use the asset dispatch schedule and the real-time data to determine asset dispatch commands to control the assets to provide power to meet the actual site load on the microgrid power system 10. For example, if the actual site load is the same as the forecasted site load, and other real-time data is consistent with the forecasted data, the real-time asset dispatch block 64 may format and output asset dispatch commands to match the asset dispatch schedule. When the actual site load is different than the forecasted site load, however, the real-time asset dispatch block 64 may modify the actual asset dispatch to meet the requirements for the actual site load with minimal variation of the generate asset dispatch schedule and output correspond asset dispatch commands to the assets, thereby providing real-time corrections to the asset dispatch schedule.

While the elements within the optimizer 54 are called “blocks” in the present disclosure, those skilled in the art will understand the term to refer to any component or components of the microgrid controller 24 or the microgrid control system 10 performing the functionality described herein. For example, the blocks 60, 62, 64 may be separate programs or function blocks executed by the processor 50 of the microgrid controller 24. Alternatively, the blocks 60, 62, 64 may be separate routines within a microgrid control program stored at the memory 52. These and further alternative implementations of the control logic disclosed herein are contemplated by the inventors as having use in microgrid control systems and strategies in accordance with the present disclosure.

In one embodiment, the microgrid control strategy in accordance with the present disclosure may implement a refueling prediction mode. In the refueling prediction mode, the microgrid controller 24 may provide an asset dispatch schedule to meet the site load based on configured asset and microgrid site constraints and parameters. In addition, based on evaluated forecasting output, the microgrid control strategy provides a timeline for refueling of fuel type assets. The refueling timeline may include both the scheduled time for refueling and the amount of fuel to add to the asset at the scheduled refueling time.

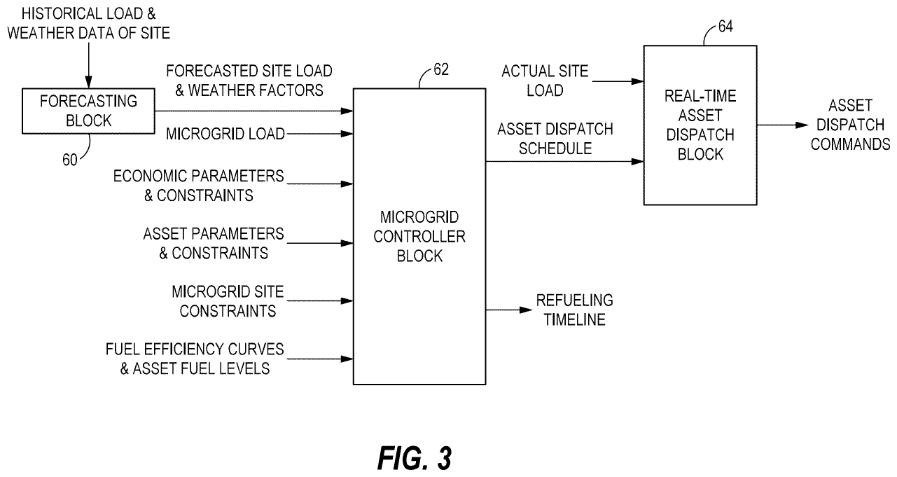

FIG. 3 illustrates an exemplary flow of information and processing within the optimizer 54 of the microgrid controller 24 in the refueling prediction mode. Initially, historical load data and weather data for the site of the microgrid power system 10 is input to the forecasting block 60. The historical load and weather data may be provided by the data resource devices 20 or other appropriate sources that may accumulate and store the information. At the forecasting block 60, the historical data is input to the forecasting algorithm to determine forecasted site load and weather factors. Forecasted site load factors can include temporary or sustained surges or lulls in load demand based on time of day, time of year, weather conditions or other factors that are not components of a scheduled load 14. Forecasted weather can include precipitation, wind speed, irradiance and the like.

The forecasted site load and weather factors are output from the forecasting block 60 to the microgrid controller block 62. A microgrid load schedule and economic, asset and site constraints and parameters are input to the microgrid controller block 62 from the data resource devices 20 or other sources as described above. In addition, fuel efficiency curves and asset fuel levels for the various available assets are input to the microgrid controller block 62. This additional information provides indications of the available fuel for assets such as the gensets 40 or the available charge at the ESSs 46, and how quickly the fuel will be combusted or charge will be dissipated during use.

With the data input, the microgrid controller 24 performs two processes in parallel. In one process, the controller logic of the microgrid controller block 62 determines an asset dispatch schedule for utilizing the available assets to meet the power requirements for the scheduled microgrid load 14 and the forecasted site load. The asset dispatch schedule may be influenced by the effect of the forecasted weather factors on the assets and the optimal refueling of the fuel type assets. Additionally, in a second process, the controller logic determines a refueling timeline for the assets. The refueling timeline is provided to the microgrid operator, site engineer or other personnel monitoring the operation of the microgrid power system 10. In this analysis, energy reserves or availability for intermittent assets such as the PV devices 42 and the wind turbines 44 may be evaluated based on forecasted data and asset parameters and constraints. The energy reserves for the non-intermittent assets such as the gensets 40 and the ESSs 46 may be evaluated based on current fuel or charge levels, fuel efficiency curves and asset parameters and constraints.

For the genset group 30, the refueling timeline may specify the refueling time and amount of fuel to add to the fuel tanks of the available gensets 40, as it may be preferable for optimizing the performance of the gensets 30 and the microgrid power system 10 to refill the gensets 30 when they are partially empty or to partially refill them when they reach a predetermined threshold. For the ESSs 46, the refueling timeline may specify when the ESSs 46 are to be connected to and recharged by the PV devices 42 or the wind turbines 44 when the forecast is favorable, or from the power grid connection 38 when other assets are not available or capable of producing power. As an example, for a microgrid power system 10 having a genset 40, PV devices 42 and ESSs 46 supporting the load 14, the power ratings for the PV devices 42 and the ESSs 46 may be sufficient to sustain the projected load 14. In this case, the genset 40 may only be triggered to operate occasionally and for short periods of time, and therefore does not burn fuel at a high rate or require frequent refilling or a full fuel tank. The critical refueling level for the genset 40 may be set to a low value, such as 5% of the tank capacity for example. Based on the current fuel levels and the asset dispatch schedule, a projected refueling timeline for the genset 40 may be provided to refill the genset 40 to 20% of the fuel tank in 3 months, to 50% of the fuel tank in 6 months, or to some other appropriate combination of fill level and fill timing. Such a strategy may reduce the inventory carrying cost for storing fuel that ma sit unused in a fuel tank for an extended period of time.

After the asset dispatch schedule and the refueling timeline are determined at the microgrid controller block 62, the asset dispatch schedule may be input to the real-time asset dispatch block 64 for use in determining asset dispatch commands to control the operation of the assets of the microgrid control system 10. The real-time asset dispatch block 64 may also receive information regarding the current operating conditions in the microgrid control system 10. Such information can include the actual site load and real-time information from the sensors 18 that are distributed throughout the microgrid power system 10. The information input to the real-time asset dispatch block 64 is used to determine the assets and their operational levels that are required to meet the actual site load on the microgrid power system 10. The real-time asset dispatch block 64 uses this information to format asset dispatch commands for the assets, and outputs the asset dispatch commands to the assets.

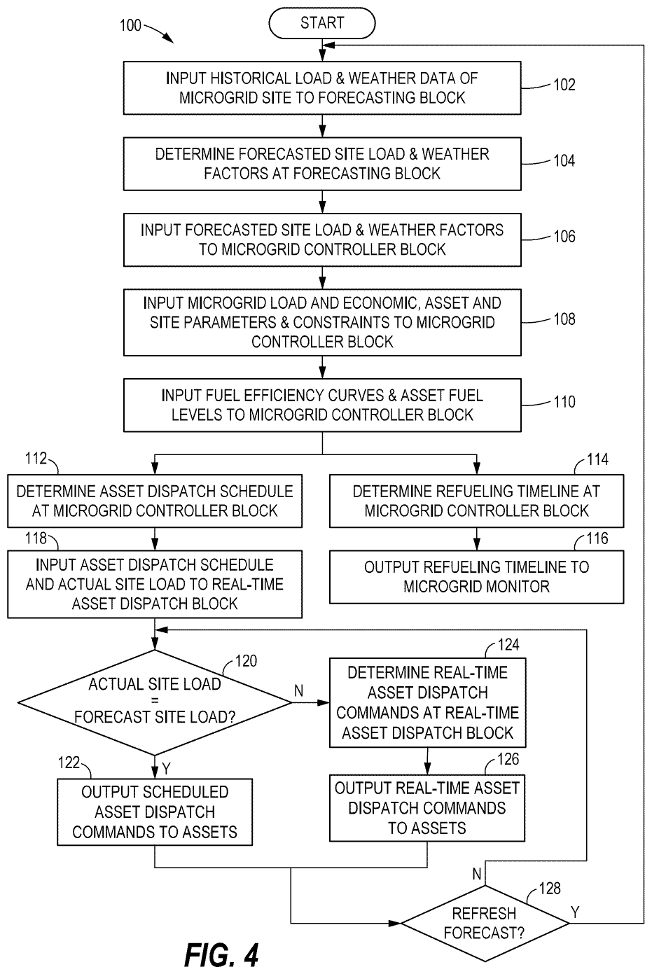

FIG. 4 illustrates an exemplary refueling prediction mode routine 100 that may be executed by the microgrid controller 24 as a control strategy for the microgrid power system 10. The routine 100 may begin at a block 102 where the historical load and weather data of the microgrid site of the microgrid power system 10 is input to the forecasting block 60. The historical load and weather data may be provided by the data resource devices 20 or other appropriate source of the historical data. After the historical data is input at the block 102, control passes to a block 104 where the forecasting algorithm at the forecasting block 60 determines the forecasted site load and weather factors from the historical data.

When the forecast algorithm completes the determination at the block 104, control passes to a block 106 where the forecasted site load and weather factors are output from the forecasting block 60 and input to the microgrid controller block 62 for use in determining the asset dispatch schedule and the refueling timeline. Additionally, at a block 108, the microgrid load and economic, asset and site parameters and constraints are input to the microgrid controller block 62. This data may be provided by the data resource devices 20, stored in the memory 52 of the microgrid controller 24, or provided by any other appropriate sources. Also, at a block 110, the fuel efficiency curves and asset fuel levels are input to the microgrid controller block 62. The fuel efficiency curves may be stored at the data resource devices 20 along with other asset configuration and identification. The asset fuel levels may be provided by appropriate sensors 18 at the assets in real time, or may be stored at the data resource devices 20 or other storage location and provided to the microgrid controller block 62 at execution of the routine 100.

With the data input to the microgrid controller block 62 at the blocks 106-110, control may pass to a block 112 where the control logic of the microgrid controller block 62 determines the asset dispatch schedule. Concurrent therewith, at a block 114 the control logic of the microgrid controller block 62 determines the refueling timeline for the microgrid power system 10 as discussed above. After determining the refueling timeline at the block 114, control passes to a block 116 where the microgrid controller 24 operates to output the refueling timeline to the microgrid operator, site engineer or other personnel monitoring the operation of the microgrid power system 10.

After determining the asset dispatch schedule at the block 112, control may pass to a block 118 where the asset dispatch schedule and the actual site load, along with other current information from the sensors 18, are input to the real-time asset dispatch block 64. As part of the processing at the real-time asset dispatch block 64, control may pass to a block 120 where the actual site load is compared to the forecasted site load that was use to determine the asset dispatch schedule at the microgrid controller block 62. If the actual site load is equal to the forecasted site load, the assets may be controlled according to the asset dispatch schedule. In such conditions, control may pass to a block 122 where the real-time asset dispatch block 64 may format and output scheduled asset dispatch commands to cause the assets to operate according to the asset dispatch schedule to handle the actual site load.

If the actual site load is not equal to the forecasted site load at the block 120, real-time corrections to the asset dispatch schedule may be necessary to properly handle the actual site load on the microgrid power system 10. In these conditions, control may pass to block 124 where the real-time asset dispatch block may determine necessary adjustments to the assent dispatch schedule and corresponding real-time asset dispatch commands that correspond to the actual site load. After determining the adjustments, control may pass to a block 126 where the real-time asset dispatch block 64 may format and output the real-time asset dispatch commands to cause the assets to operate according to the adjusted asset dispatch schedule to handle the actual site load.

After asset dispatch commands are output to the assets at either block 122 or block 126, control may pass to a block 128 to determine whether a predetermined period of time has elapsed for refreshing the forecast for the asset dispatch schedule and the refueling timeline. It may be helpful or necessary to recalculate the asset dispatch schedule and refueling timeline from time to time to ensure that the microgrid power system 10 is operating optimally as conditions change and update data is available. The refresh rate may be relatively short, such as fractions of an hour, where conditions within and without the microgrid power system 10 are relatively volatile and the real-time asset dispatch commands may quickly diverge from the asset dispatch schedule. In other implementations where the microgrid power system 10 is relatively stable and the actual conditions closely match the forecasted conditions, the refresh rate may be relative long, such as several hours, a day or days, or longer. If the microgrid controller 24 determines at the block 128 that the period of time according to the refresh rate has not been reached and it is not yet necessary to refresh the forecast, control may pass back to the block 120 to continue comparing the actual site load to the forecasted site load and outputting asset dispatch commands accordingly. If the period of time according to the refresh rate has been reached at the block 128, it is time to refresh the forecast and control may pass back to the block 102 to reinitiate the process for determining the asset dispatch schedule and the refueling timeline. The routine 100 may continue executing in this iterative manner as long as the microgrid power system 10 is operated under the refueling prediction mode.

The operation of the microgrid controller 24 may be dependent on the configuration of the microgrid power system 10, such as the level of automation provided in the system 10. For example, in executing real-time asset dispatch, the microgrid controller 24 may be able to communicate with the loads 14, the power asset groups 16 and switches (not shown) of the HV bus 22a to transmit control signals to operate the power asset groups 16 and the route power through the system 10 between the loads 14 and the power asset groups 16 via the switches. Where less automation is available, all or portions of the real-time asset dispatch may be executed by communications between the microgrid controller 24 and the user devices 12 to alert the users 26 to operate the loads 14, the power asset groups 16 and the electronic network 22 to operate the microgrid power system 10. The refueling timeline may be executed in a similar manner depending on the level of automation of the microgrid power system 10.

In a further embodiment, the microgrid control strategy in accordance with the present disclosure may implement a sustained reliability mode. In the sustained reliability mode, the microgrid controller 24 may dispatch assets based on forecasted load and weather, current fuel levels, real-time fuel costs, fuel efficiency curves and user configured economic, asset and site constraints and parameters such that the forecasted load can be sustained for the longest duration without refueling. The sustained reliability mode may be applicable in situations where refueling of the assets is not possible or is limited, such as at a disaster site or a remote site where access to fuel is greatly restricted or unavailable. Based on user configuration of the microgrid controller 24 and the control logic of the microgrid controller block 62, the microgrid controller 24 may have the flexibility to shed non-essential loads 14 to sustain the microgrid power system 10 for a longer duration, and to judiciously utilize critical assets with low fuel levels and limited or nonexistent opportunity for refueling. For example, if refueling is not possible in the immediate future due to fuel unavailability or prohibitively high fuel costs, a critical asset such as a grid-forming capable diesel genset 40 with a low fuel level would be dispatched to provide power judiciously by the microgrid controller 24 such that most of the microgrid load 14 is supported by other high fuel level assets to sustain the microgrid power system 10 for the longest possible duration. The grid-forming diesel genset 40 could be operated in times of critical need, but then shut down in non-grid-forming applications to preserve its limited fuel. However, the grid-forming diesel genset 40 may not be shut down when performing grid-forming applications. To implement the sustained reliability mode, the microgrid load and asset parameters and constraints may be configured accordingly to identify the critical or non-critical nature of the microgrid loads and assets.

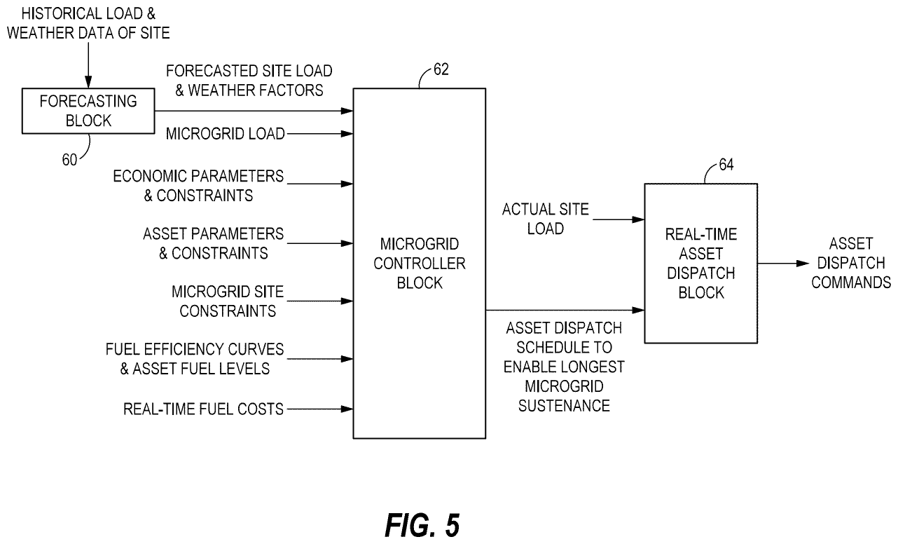

FIG. 5 illustrates an exemplary flow of information and processing within the optimizer 54 of the microgrid controller 24 in the sustained reliability mode. Much of the information flow is similar to that occurring for the refueling prediction mode in terms of generating the forecasted site load and weather factors, and inputting those factors along with the microgrid load, economic, asset and site parameters and constraints and fuel efficiency curves and asset fuel levels to the microgrid controller block 62. In addition, real-time fuel costs may be input to the microgrid controller block 62. The real-time fuel costs can include information such as export costs, cost of drawing power from and sending power to the power grid connection 38, peak versus non-peak fuel costs, diesel fuel cost fluctuations, and the like.

With the data input, the controller logic of the microgrid controller block 62 determines an asset dispatch schedule that enables the longest sustainable operation of the microgrid power system 10. As discussed, optimization of sustainable operation may be achieved through a combination of judicious use of reliable fuel limited assets and reduction or elimination of non-essential loads. In this determination, cost may be less important than reliability and duration of operation. To the extent that cost is relevant and there is desire to balance reliability with economic factors, such tradeoffs can be added in the parameters and constraints input to the microgrid controller block 62 to determine the asset dispatch schedule that is input to the real-time asset dispatch block 64 to determine and output asset dispatch commands.

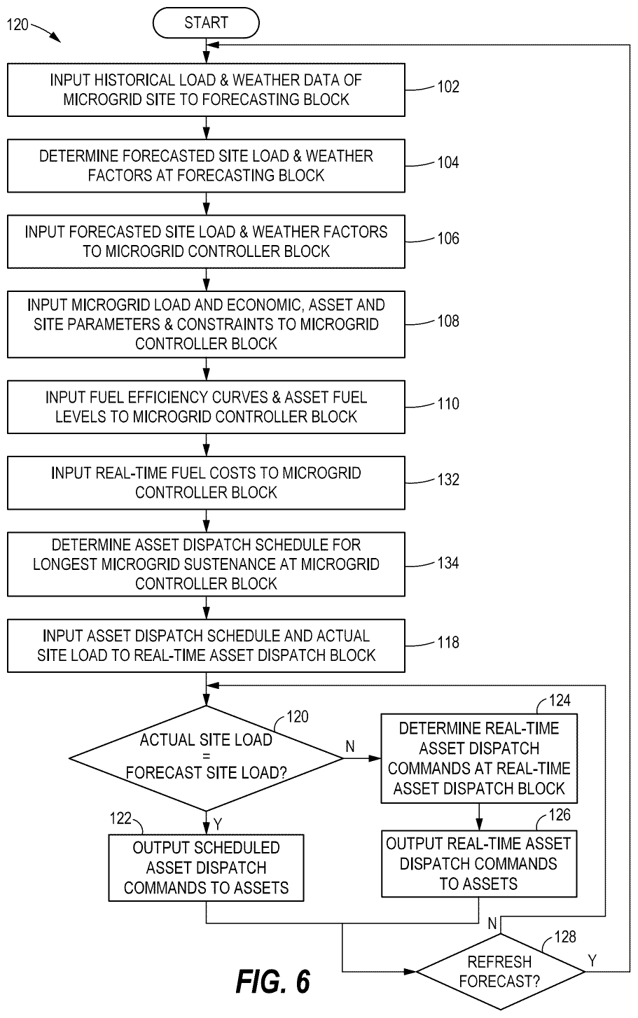

FIG. 6 illustrates an exemplary sustained reliability mode routine 120 that may be executed by the microgrid controller 24 as a control strategy for the microgrid power system 10. Similar to the flow of information in FIG. 5, the routine 130 may begin in a similar manner as the refueling prediction mode routine at blocks 102-110 to determine the forecasted site load and weather factors and input the factors, parameters and constraints and fuel efficiency curves and asset fuel levels to the microgrid controller block 62. At a block 132, the real-time fuel costs are input to the microgrid controller block 62. The real-time fuel costs may be stored at the data resource devices 20 or may be obtained from other sources with access to the real-time cost information.

With the data input to the microgrid controller block 62 at the blocks 106-110 and 132, control may pass to a block 134 where the control logic of the microgrid controller block 62 determines the asset dispatch schedule that yields the longest microgrid sustenance as discussed above. After determining the sustained reliability asset dispatch schedule at the block 134, control passes to blocks 120-158 where the microgrid controller 24 operates to determine and output asset dispatch commands according to the sustained reliability asset dispatch schedule and actual site load, along with other real-time data, in the microgrid power system 10 in a similar manner as discussed above depending on the level of automation of the microgrid power system 10.

### INDUSTRIAL APPLICABILITY

Refueling based on informed predictions can lead to a reduction in refueling frequency that in turn leads to fuel cost reduction. These can include reductions in purchase cost, transportation cost, cost of inventory and the like. These savings are realized over previous microgrid control strategies that result in uniformed, reactionary and immediate refueling that can increase to working capital expenditure for the microgrid power system. Information regarding refueling requirements can assist in optimizing the fuel reserve maintained for the assets and avoiding situations of maintaining excess fuel reserves, which correspondingly reduce operational expenditures. Calculating asset dispatch based on fuel levels and real-time fuel costs facilitates sustaining reliable operation of the microgrid power system 10 for longer durations, especially when reliable operation of the microgrid power system 10 is paramount.

While the preceding text sets forth a detailed description of numerous different embodiments, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

It should also be understood that, unless a term was expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to herein in a manner consistent with a single meaning, that is done for sake of clarity only so as to not confuse the reader, and it is not intended that such claim term be limited, by implication or otherwise, to that single meaning.

What is claimed is:

1. A method for refueling prediction in a microgrid power system comprising:
inputting historical load and weather date of the microgrid power system to a forecasting block;
determining, at the forecasting block, forecasted site load and weather factors for the microgrid power system;
inputting the forecasted site load and weather factors to a microgrid controller block;
inputting fuel efficiency curves and asset fuel levels for power assets of the microgrid power system to the microgrid controller block;
determining, at the microgrid controller block, an asset dispatch schedule for the power assets of the microgrid power system based on the forecasted site load and weather factors;
determining, at the microgrid controller block, a refueling timeline for the power assets of the microgrid power system based on the forecasted site load and weather factors, the fuel efficiency curves and the asset fuel levels;
outputting the refueling timeline to a monitor of the microgrid power system;
determining, at real-time asset dispatch block, asset dispatch commands based on the asset dispatch schedule and an actual site load; and
outputting the asset dispatch commands to the power assets of the microgrid power system.

2. The method of claim 1, comprising:
inputting microgrid load and economic, asset and site parameters and constraints for the microgrid power system to the microgrid controller block; and
determining, at the microgrid controller block, the refueling timeline for the power assets of the microgrid power system based on the microgrid load and economic, asset and site parameters and constraints.

3. The method of claim 1, comprising:
comparing, at the real-time asset dispatch block, the actual site load to the forecast site load;
setting the asset dispatch commands equal to scheduled asset dispatch commands corresponding to the asset dispatch schedule in response to determining that the actual site load is equal to the forecasted site load; and
setting the asset dispatch commands equal to real-time asset dispatch commands corresponding to the asset dispatch schedule and the actual site load in response to determining that the actual site load is not equal to the forecasted site load.

4. The method of claim 1, wherein the refueling timeline includes a scheduled time for refueling a fuel type power asset and an amount of fuel to add to a fuel tank of the fuel type power asset at the scheduled time for refueling.

5. The method of claim 1, wherein the asset fuel levels for the power assets include an available charge at an energy storage system (ESS).

6. The method of claim 1, wherein the refueling timeline includes a scheduled time for connecting an energy storage system (ESS) to an intermittent power asset that is dependent on the forecasted weather factors to generate power to recharge the ESS when the forecasted weather factors indicate that the intermittent power asset will have power to charge the ESS.

7. The method of claim 1, wherein the refueling timeline includes a scheduled time for connecting an energy storage system (ESS) to a power grid connection to recharge the ESS when the forecasted weather factors indicate that the intermittent power asset will not have power to charge the ESS.

8. A method for sustained reliability of a microgrid power system comprising:
inputting historical load and weather date of the microgrid power system to a forecasting block;
determining, at the forecasting block, forecasted site load and weather factors for the microgrid power system;
inputting the forecasted site load and weather factors to a microgrid controller block;
inputting fuel efficiency curves and asset fuel levels for power assets of the microgrid power system to the microgrid controller block;
inputting real-time fuel costs for the power assets to the microgrid controller block;
determining, at the microgrid controller block, an asset dispatch schedule for longest microgrid sustenance for the power assets of the microgrid power system based on the forecasted site load and weather factors, the fuel efficiency curves and the asset fuel levels, and the real-time fuel costs;
determining, at real-time asset dispatch block, asset dispatch commands based on the asset dispatch schedule and an actual site load; and
outputting the asset dispatch commands to the power assets of the microgrid power system.

9. The method of claim 8, comprising:
inputting microgrid load and economic, asset and site parameters and constraints for the microgrid power system to the microgrid controller block; and
determining, at the microgrid controller block, the asset dispatch schedule for the power assets of the microgrid power system based on the microgrid load and economic, asset and site parameters and constraints.

10. The method of claim 8, wherein the real-time fuel costs include one or more of fuel export costs, costs of drawing power from a power grid connection, costs of sending power to the power grid connection, peak fuel costs and non-peak fuel costs.

11. The method of claim 8, wherein the asset dispatch schedule includes operating a high fuel level non-critical power asset as a substitute for a low fuel level critical power asset.

12. The method of claim 8, wherein the asset dispatch schedule includes not providing power to a non-essential component of a microgrid load.

13. The method of claim 8, comprising:
comparing, at the real-time asset dispatch block, the actual site load to the forecast site load;
setting the asset dispatch commands equal to scheduled asset dispatch commands corresponding to the asset dispatch schedule in response to determining that the actual site load is equal to the forecasted site load; and
setting the asset dispatch commands equal to real-time asset dispatch commands corresponding to the asset dispatch schedule and the actual site load in response to determining that the actual site load is not equal to the forecasted site load.

14. A microgrid power system comprising:
a microgrid load requiring power from the microgrid system;
a plurality of power assets of different power asset types providing power to the microgrid power system;
an electronic network connecting the microgrid load and the plurality of power assets for transferring power and for communicating monitoring and control information; and
a microgrid controller operatively connected to the microgrid load, the plurality of power assets and the electronic network, the microgrid controller configured to:
receive historical load and weather date of the microgrid power system,
determine forecasted site load and weather factors for the microgrid power system,
receive fuel efficiency curves and asset fuel levels for the plurality of power assets,
determine an asset dispatch schedule for the power assets of the microgrid power system based on the forecasted site load and weather factors,
determine a refueling timeline for the plurality of power assets based on the forecasted site load and weather factors, the fuel efficiency curves and the asset fuel levels,
output the refueling timeline to a monitor of the microgrid power system,
determine asset dispatch commands based on the asset dispatch schedule and an actual site load, and
output the asset dispatch commands to the power assets of the microgrid power system.

15. The microgrid power system of claim 14, wherein the microgrid controller is configured to:
receive microgrid load and economic, asset and site parameters and constraints for the microgrid power system; and
determine the refueling timeline for the plurality of power assets of the microgrid power system based on the microgrid load and economic, asset and site parameters and constraints.

16. The microgrid power system of claim 15, wherein the microgrid controller is configured to:
compare the actual site load to the forecast site load;
set the asset dispatch commands equal to scheduled asset dispatch commands corresponding to the asset dispatch schedule in response to determining that the actual site load is equal to the forecasted site load; and
set the asset dispatch commands equal to real-time asset dispatch commands corresponding to the asset dispatch schedule and the actual site load in response to determining that the actual site load is not equal to the forecasted site load.

17. The microgrid power system of claim 16, wherein the microgrid controller is configured to:
receive real-time fuel costs; and
determine the asset dispatch schedule for longest microgrid sustenance for the plurality of power assets based on the forecasted site load and weather factors, the fuel efficiency curves and the asset fuel levels, and the real-time fuel costs.

18. The microgrid power system of claim 17, wherein the asset dispatch schedule includes operating a high fuel level non-critical power asset of the plurality of power assets as a substitute for a low fuel level critical power asset of the plurality of power assets.

19. The microgrid power system of claim 14, wherein the asset fuel levels for the plurality of power assets include an available charge at an energy storage system (ESS).

20. The microgrid power system of claim 14, wherein the refueling timeline includes a scheduled time for connecting an energy storage system (ESS) of the plurality of power assets to an intermittent power asset of the plurality of power assets that is dependent on the forecasted weather factors to generate power to recharge the ESS when the forecasted weather factors indicate that the intermittent power asset will have power to charge the ESS, and includes a scheduled time for connecting the ESS to a power grid connection to recharge the ESS when the forecasted weather factors indicate that the intermittent power asset will not have power to charge the ESS.
